(19) United States
(12) Patent Application Publication
(10) Pub. No.: US 2004/0093343 A1
(43) Pub. Date: May 13, 2004

(54) Enhanced client relationship management systems and methods

(76) Inventors: Scott Lucas, Palm Desert, CA (US); Erik Moore, Austin, TX (US); David Lee, Mission Viejo, CA (US)

Correspondence Address: FISH & NEAVE, 1251 AVENUE OF THE AMERICAS, 50TH FLOOR, NEW YORK, NY, 10020-1105, US

(21) Appl. No.: 10/293,393

(22) Filed: Nov. 12, 2002

(51) Int. Cl. G06F 7/00

(52) U.S. Cl. 707/102

(57) ABSTRACT

The present invention relates to customer relationship management systems and methods for receiving information objects in a variety of formats from a variety of information sources and communicating the objects to client. A CRM application may be provided for storing client-associated information (e.g., keyphrases related to client interests, client holdings, etc.) in an application database and used to search for objects in at least one information source. Objects retrieved from a search may be presented to the user according to their relevance to the search. Objects may be communicated to a client using a communication application such as an electronic mail application or a telephone application included as part of a user interface. Objects may be summarized using a text summary algorithm before being communicated to a client. Product information and closed captioned television information may be received by the CRM application, searched using client-associated information, and communicated to a client.

### BACKGROUND OF THE INVENTION

The present invention relates to systems and methods for enhancing client relationship management (CRM). More particularly, the present invention relates to systems and methods for allowing relationship managers to provide clients with timely information in a variety of formats from a variety of sources so that clients can make better informed decisions.

One key element in a successful partnership between relationship managers and their clients is the exchange of timely and relevant communication. Traditional relationship managers include brokers, agents, sales professionals, stock brokers, financial advisors, real estate agents, travel agents, insurance agents, professionals (such as doctors and lawyers), and any person who initiates contact with clients or customers. The goal of a successful relationship manager is to develop and enhance relationships with clients. However, relationship managers lack the adequate tools for perpetuating new reasons to contact clients to achieve these goals.

Known CRM systems and methods currently exist that only solve the problem of organizing client information after the relationship manager has already initiated contact with the client or potential client. For example, CRM applications are used to collect information about the client and record notes regarding prior conversations with the client. However, these applications do not adequately assist the relationship manager in making new contact with a client, which would further enhance the relationship.

One of the most significant attributes a successful relationship manager must have is the ability to stay abreast of news and information which affects their area of specialization as well as the interests of their clients. To accomplish this end, relationship managers may use a variety of tools, in addition to CRM applications, to collect and distribute information to their clients. For example, relationship managers may use web browsers with a search engines, television information sources, or other tolls that are separate from the CRM application for locating information that may be of interest to their clients. The relationship manager must then manually sort through vast amounts of information received from these sources to determine information that may be of interest to their clients.

The relationship manager may use communication devices, such as a telephone or electronic mail, to disseminate this information to their clients. Because so much information exists in today's economy, it is virtually impossible for a relationship manager to manually search for, retrieve, review and communicate to a client all available information that will enhance the client's ability to make better decisions.

Commonly-assigned U.S. patent application Ser. No. 09/966,355, filed Sep. 28, 2001 (“the '355 application”), which is incorporated by reference herein in its entirety, presents various solutions to these and other problems associated with managing professional relationships. As a front-end application software database architecture and information delivery tool with a comprehensive, functional graphical user interface, the invention disclosed in the '355 application allows relationship managers (“users”) to import existing client lists, add or create client profiles, generate “to-do” lists and action items, retrieve text, web sites, articles, and documents from one or more databases, add one or more keyphrases related to client interests to each client profile and, optionally, add user-based keyphrases.

In addition, the invention disclosed in the '355 application allows users to perform queries on informational databases for objects such as articles containing one or more keyphrases stored in an application database, and displays the retrieved results list with corresponding keyphrase, title, published date and associated clients who have profiles with matching keyphrases. The user may add retrieved articles to an action list, edit the retrieved information and edit client profiles stored in the database.

The invention disclosed in the '355 application also includes point and click electronic mail functionality for retrieved objects or imported objects and also searches the body of the retrieved or imported object for keyphrases based on client profiles and returns names of clients who may be interested. The '355 application also allows a user to import plain text or entire files from any external source, such as text from a news article, or a text document file.

However, additional features may be implemented to the platform of the '355 application to further facilitate users in developing and enhancing relationships with clients. For example, it would be desirable to better integrate CRM applications with telephonic communication systems and methods to provide clients with a more immediate and personalized level of service.

It would also be desirable for users to provide clients with more concise information as well as information in multimedia file formats, such as downloadable or streaming audio and video files.

It would also be desirable for users to provide clients with more timely and accurate information such as breaking news stories or other real-time television program information.

It would also be desirable to allow users to track information related to a client's holdings, and receive and communicate to clients information related to these holdings, for example information related to the client's product holdings or information related to other products similar to the client's holdings.

It would also be desirable to provide the relationship manager with a relevancy rating associated with the information received from information sources to determine the most relevant information to manage and communicate to clients.

It would also be desirable to provide users with e-mail reminders for action items and alerts for new information received.

It would also be desirable to provide faster and more flexible functionality associated with importing and disseminating information to clients.

### SUMMARY OF THE INVENTION

It is therefore an object of the present invention to implement telephonic communication systems and methods for providing clients with a more immediate and personalized level of service.

It is also an object of the present invention to allow users to provide clients with more concise information as well as information in multimedia file formats, such as downloadable or streaming audio and video files.

It is also an object of the present invention to allow users to provide clients with more timely and accurate information such as breaking news stories or other real-time television program information.

It is also an object of the present invention to allow users to track information related to client holdings, and receive and convey to clients information related to these holdings.

It is also an object of the present invention to provide the relationship manager with a relevancy rating associated with the information received from information sources to determine the most appropriate information to manage and communicate to clients. Objects may be presented to the user according to their relevancy rating.

It is also an object of the present invention to provide users with e-mail reminders for action items and alerts for new information received.

It is also an object of the present invention to provide faster and more flexible functionality associated with importing and immediately disseminating information to clients.

These and other objects of the present invention are accomplished in accordance with the invention by providing enhanced client relationship management systems and methods. For example, a CRM application may be provided for receiving information objects in a variety of formats from a variety of information sources. Objects may be text files, web pages, portable document format files, downloadable video and audio files, real-time streaming video broadcasts, web-based audio broadcasts, television programs, information related to products, or any other information in any available format.

Objects may be searched and retrieved based on user-associated or client-associated information (e.g., keyphrases, holdings, or any other information that may be mapped to a user or client profile). Retrieved objects may then be reviewed by the user and the information may be summarized and communicated via a communication application, such as a telephone application, electronic mail application, or by any other available communication device or application (e.g., via pager, real-time videoconference, etc.).

Objects may be retrieved by a user in response to the user executing a search request for a particular client or keyphrase. Objects retrieved may be rated according to their relevancy to the client or keyword searched. Information may be dynamically updated periodically so that the user is informed of breaking news without having to perform a search request to receive relevant objects. Users may also be provided with an opportunity to retain, and later view, selected objects, schedule searches to occur at a particular time or frequency, and set alerts for particular information. Users and clients may receive reminders and alerts via e-mail, telephone, wireless pager, or by any other method.

An enhanced user interface may be provided that lists clients according to priority. The user interface may present various frames, and the user may browse the information requested using tabs identifying data silos. Data silos refer to groupings of information based on, for example, the type, source, or use of the information.

### BRIEF DESCRIPTION OF THE DRAWINGS

The above and other objects and advantages of the invention will be more apparent upon consideration of the following detailed description, taken in conjunction with the accompanying drawings, in which like reference numerals refer to like parts throughout, and in which:

FIG. 1 is a diagram of illustrative software and hardware used in accordance with the present invention;

FIGS. 2-7 show illustrative screens for presenting, providing access to and communicating to clients objects retrieved from a search in accordance with the present invention;

FIGS. 8 and 9 are flow charts of illustrative steps involved in accessing and taking action on objects retrieved from a search in accordance with the present invention;

FIGS. 10-12 show illustrative screens for entering and presenting client holdings information and locating objects related to client holdings in accordance with the present invention;

FIG. 13 is flow chart of illustrative steps involved in entering client holdings information and locating objects related to client holdings in accordance with the present invention;

FIGS. 14 and 15 show illustrative screens for importing external objects in accordance with the present invention;

FIG. 16 is a flow chart of illustrative steps involved in importing external objects in accordance with the present invention;

FIG. 17 is a flow chart of illustrative steps involved in associating clients with products in accordance with the present invention; and

FIG. 18 is a flow chart of illustrative steps involved in utilizing real-time streaming broadcast of television program information in accordance with the present invention.

### DETAILED DESCRIPTION

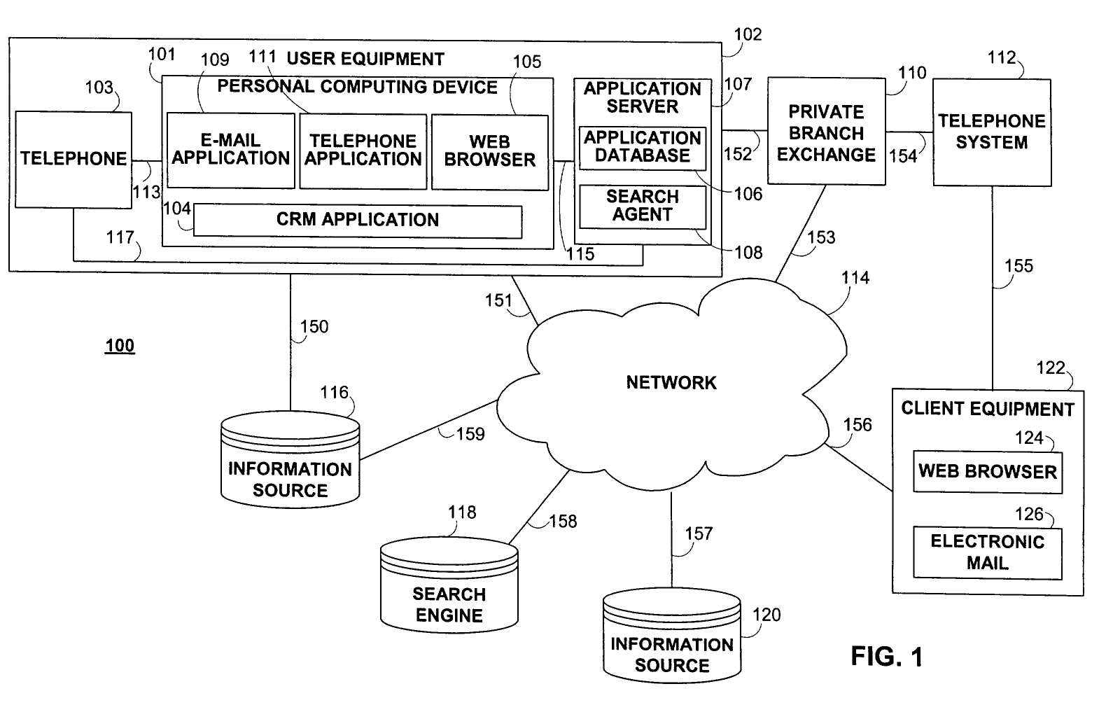

The present invention is now described in more detail in conjunction with FIGS. 1-18.

FIG. 1 is a schematic diagram 100 of illustrative software and hardware that may be used to implement the systems and methods of the present invention. In FIG. 1, the relationship manager (“user”) may operate user equipment 102, which may include, for example, personal computing device 101, telephone 103, application server 107, any other suitable device or devices, or a combination thereof. Personal computing device 101 may be a personal computer (e.g., an IBM-compatible PC, an apple computer, etc.), a handheld computing device (e.g., a personal digital assistant), a wireless computing device, or any other suitable computing device. Telephone 103 may be any suitable wired or wireless telephone based on a telephone network. Application server 107 may be, for example, a web server, an enterprise server, a mainframe computer, any other suitable computing device or devices, or a combination thereof. Other hardware components of user equipment 102 and combinations of hardware components may also exist. For example, user equipment 102 may include two types of a personal computing device 101 (e.g., a personal computer and a personal digital assistant). However, for brevity and clarity, only personal computing device 101, telephone 103, and application server 107 are shown.

The devices comprising user equipment 102 may include appropriate hardware (e.g., circuits, processors, memory, user input devices, display devices, etc.) needed for implementing algorithms or software applications, for example, CRM application 104, web browser 105, e-mail application 109, telephone application 111, search agent 108, or any other suitable algorithm or software application.

Search agent 108 may include any conventional search algorithm for searching a database of information using search parameters and may be implemented by application server 107 or any other suitable device included in user equipment 102. Application database 106 may also be implemented by application server 107 or by any other suitable device included in user equipment 102. Application database 106 may be, for example, any number of multi-tiered databases for storing information such as information related to user profiles, client profiles, and any other relevant information. User profiles may include, for example, a list of clients, user personal information, keyphrases associated with a user's interest or specialty, or any other available information. Client profiles may include information related to a client's personal information, keyphrases related to client interests, client holdings, or any other suitable information. The information in application database 106 may be in any suitable data management format, environment, or application, for example, a relational database format, an object oriented database format, a data warehouse, a data directory, a knowledge management system, or any other suitable device, environment or application for storing and indexing related information.

In FIG. 1, CRM application 104, web browser 105, e-mail application 109, and telephone application 111 are each implemented by personal computing device 101 while application database 106 and search agent 108 are implemented by application server 107. It will be understood, however, that the software applications used in connection with the present invention may be implemented by any device included as part of user equipment 102 and that the single embodiment of FIG. 1 is used merely as an illustration. For example, in one embodiment, such as the case of a perfectly distributed network (e.g., thin-client computing, application service provider, etc.), all software applications may be implemented by application server 107, while personal computing device may only include a user interface. In another embodiment telephone application 111 and any other suitable software application (e.g., e-mail application 109, web browser 105, etc.) may be implemented by telephone 103, for example if telephone 103 is a web-enabled telephone capable of web browsing as well as conventional telephone functions.

The components of user equipment 102 may be located adjacent to one another (as shown) or remote from one another. For example, application server 107 may be located at a site remote for personal computing device 101 and telephone 103, and may be accessed using network 114, which may be any local or wide area network. Personal computing device 101, telephone 103, and application server 107 may communicate via communication paths 113, 115 and 117, which may be any suitable wired or wireless communications path. For example, if wire-based, communication paths 113, 115 and 117 may be serial connections, parallel connections, telephone cables, copper wire, electric cable, fiber optic cable, coaxial cable, Ethernet cable, USB cable, Firewire cable, component video cables, composite cables, any other suitable wire-based communications path, or any combination thereof. If wireless, any suitable communications protocol or standard such as IEEE 802.11, wireless application protocol (WAP), radio frequency (RF), Bluetooth, (Extended) time division multiple access (TDMA), code-division multiple access (CDMA), global systems for mobile communications (GSM), or any other suitable wireless communications path or protocol may be used. A combination of wired and wireless communication paths may also be used.

User equipment 102 may be coupled to network 114 via communications path 151. Network 114 may be a local or wide area network (e.g., the Internet, an intranet, etc.) and may support any combination of wired, wireless, or optical communications. Information may be provided to user equipment 102 from various information sources and search engines 116, 118, and 120 which may be coupled to network 114 via communications paths 159, 158, and 157, respectively. Information sources may also be directly coupled to user equipment 102 without network 114, for example via communications path 150 providing a dedicated communications link between information source 116 and user equipment 102. It will be understood that many instances and types of information sources and search engines may be coupled to network 114. However, for brevity and clarity only several are shown in FIG. 1.

User equipment 102 may be coupled to private branch exchange (PBX) 110 via communications path 152. It will be understood that PBX 110 may be any telephone communication system capable of placing telephone calls from a user to a client. For the purposes of brevity and clarity, only PBX 110 is shown in FIG. 1. In embodiments where user equipment is part of a corporate communications infrastructure, numerous PBX servers may be used. In other embodiments of the present invention, for example in the case of a self-employed relationship manager, a PBX server may not be necessary and the user may communicate with the client directly using a conventional telephone system (e.g., telephone system 112 which may include a Public Switched Telephone Network (PSTN), a cellular network, a satellite telephone systems, etc.).

PBX 110 may generate analog or digital audio signals. Analog audio signals may be communicated to telephone system 112 via communications path 154. It will be understood that telephone system 112 may be any available combination of wire-based and wireless communications systems capable of supporting analog communication signals (e.g., a PSTN or any other suitable network). However, for clarity and brevity, only telephone system 112 is shown in FIG. 1. Digital audio signals generated by PBX 110 may be communicated to network 114 via communications path 153. Digital audio signals may also be generated by user equipment 102 and communicated to network 114 via communications path 151. Network 114 may support an Internet Protocol (IP) capable of supporting voice-data in a digital format (e.g., voice-over-IP using discreet data packets).

Digital audio signals communicated from telephone system 112 via communications path 155 or from network 114 via communications path 156 may be received by client equipment 122. Client equipment 122 may include a personal computing device, a handheld computing device, a wireless computing device, a wired or wireless telephone, a web-enabled telephone, or any other device or combination of devices. Client equipment may include communication applications such as web browser 124, electronic mail 126, or any other suitable computing or communications device or application (e.g., a telephone, a telephone application, etc.). It will be understood that some embodiments of the present invention may include several instances of client equipment 122, used respectively by each of several clients. However, for the purposes of clarity and brevity, only one instance of client equipment 122 is shown.

Communications paths 150-159 may be any suitable wired or wireless communications path. For example, if wire-based, communications paths 150-159 may be serial connections, parallel connections, telephone cables, copper wire, electric cable, fiber optic cable, coaxial cable, Ethernet cable, USB cable, FireWire cable, component video cables, composite cables, any other suitable wire-based communications path, or any combination thereof. If wireless, any suitable communications protocol or standard such as IEEE 802.11, wireless application protocol (WAP), radio frequency (RF), Bluetooth, (Extended) time division multiple access (TDMA), code-division multiple access (CDMA), global systems for mobile communications (GSM), or any other suitable wireless communications path or protocol may be used. A combination of wired and wireless communication paths may also be used. Communications paths 151, 153, and 156-159 may provide access to network 114 via a web server, a network gateway, any other suitable device, or a combination thereof.

The software and hardware illustrated in FIG. 1 may be used to implement the systems and methods of the present invention. For example, a user may operate user equipment 102 to access CRM application 104 for creating user profiles having user-associated information or client profiles having client-associated information. Because more than one user may be provided access to the CRM application, it may be necessary to provide each user with a distinct profile to distinguish between users. User profiles may include user-associated information such as a list of clients, user personal information, keyphrases associated with a user's interest or specialty, or any other suitable information. Using CRM application 104, each user may create client profiles having client-associated information, which may include personal information, keyphrases related to a client's interests, client product holdings, or any other suitable information. User profiles and client profiles and all associated information may be stored in application database 106.

Information stored in external information sources 116, 118, and 120 may be accessed by user equipment 102, and users may search the information and retrieve objects using user-associated information from user profiles (e.g., user keyphrases) or client-associated information from client profiles (e.g., keyphrases related to a client's interests, client holdings, etc.). Objects may include various types of information (e.g., news articles, streaming media, information related to products, television program information, information related to a conference call, a securities exchange commission (SEC) filing, etc.) in any available format, for example, text files, web pages, portable document format files, downloadable video and audio files, real-time streaming videos broadcasts, web-based audio broadcasts, or any other suitable available information format.

The CRM application may identify objects retrieved from a search as being related to a particular user or client by matching the object's text, metadata, or other information associated with the object (e.g., keyphrases), to information associated with the user or client. Objects identified as being related to the user or client may be displayed to the user, and the user may select objects to review. Once an object has been identified as related to a user or client, the object may be searched using information associated with other users or clients to determine if further relations exist between the selected object, users, and clients. Systems and methods for searching information sources using user-associated and client associated information is described in greater detail in the '355 application.

A communication application such as telephone application 111 implemented on user equipment 102 may be used in conjunction with the CRM application to provide a user with an opportunity to call a client. A personal computer having a telephone application may require peripheral devices to provide telephone functionality, for example a microphone, speakers, a headset, or any other suitable peripheral hardware. Telephone applications are widely available that allow users to communicate between two personal computing devices, between a personal computing device and a telephone, between two telephones, or by way of other suitable communication devices. Telephone applications may use various networks and support various protocols to allow communication between devices. For example, communication between devices may occur over the Internet (using an Internet protocol that supports the transmission of voice data), over a PSTN, via a private branch exchange, or by any other suitable method.

In connection with FIG. 1, telephone application 111 may provide a user at user equipment 102 with an opportunity to place a telephone call to a client at client equipment 122. Upon receiving indication from the user to call the client, the telephone application may retrieve the client's telephone number from application database 106 and automatically dial the client's telephone number. The telephone call may be placed to the client via network 114 or via telephone system 112 which may or may not require use of PBX 110. The telephone application may establish a client connection at client equipment 122 and the client may receive the telephone call using a personal computer, a telephone, any other suitable device or devices, or a combination thereof. The telephone application may also establish a user connection using a personal computer, a telephone, any other suitable device or devices, or a combination thereof. Once the telephone application establishes both a user and client connection, a telephone conversation between the user and the client my ensue.

In one embodiment, both the user's connection and the client's connection may be established using telephone applications implemented by their respective personal computing device. In this embodiment, the user's personal computing device may place a telephone call to the client's personal computing device, and the user's telephone application may divide voice data received by the user into discreet digitized voice packets. The telephone application may then send the discreet digitized voice packets to the client's telephone application over a public or private network (e.g., an intranet, the Internet, etc.). The user's telephone application may use any suitable method for communicating the voice data to the client over a public or private network. For example, the user's telephone application may “tunnel” telephone calls, wherein the data intended for use only within a private network is transmitted through a public network in such a way that the routing nodes in the public network are unaware that the transmission is part of a private network.

In another embodiment, the user's connection may be established using a personal computing device while the client's connection may be established using a conventional telephone. In this embodiment, the telephone application may be implemented by the user's personal computing device and may be used to transmit voice data over the Internet. The voice data received by the user at the personal computing device may be divided into discreet digitized data packets and sent to the client over the Internet. A network gateway may be used to reassembled and decompress the voice data (if needed) and complete transmission of the voice data to the client using a conventional telephone system (e.g., a PSTN or other suitable network). In this embodiment, as the voice data is being transmitted over the Internet, tunneling or any other suitable method of communicating voice data over the Internet may be used. In a similar embodiment, the user's connection may be established using a conventional telephone and the client's connection may be established using a personal computer. Methods similar to those described above may be used in such an arrangement for allowing communication between the user and the client.

In another embodiment, the telephone call may be connected between two conventional telephones. In this embodiment, a telephone application may or may not be implemented by the telephone devices used by the user and the client. If used, the telephone application may dial into a gateway at the user's end and voice data may be divided into discreet digitized voice packets, compressed, and transmitted over the Internet. When the voice data is received at user equipment 122, the discreet voice data may be reassembled, decompressed, and transmitted to the client via a conventional telephone system (e.g., a PSTN). If a telephone application is not used, the user may place a telephone call to the client using conventional telephone calling methods (e.g., using a conventional telephone to manually dial a telephone number and placing a call via a PSTN, a cellular network, or any other available telephone network).

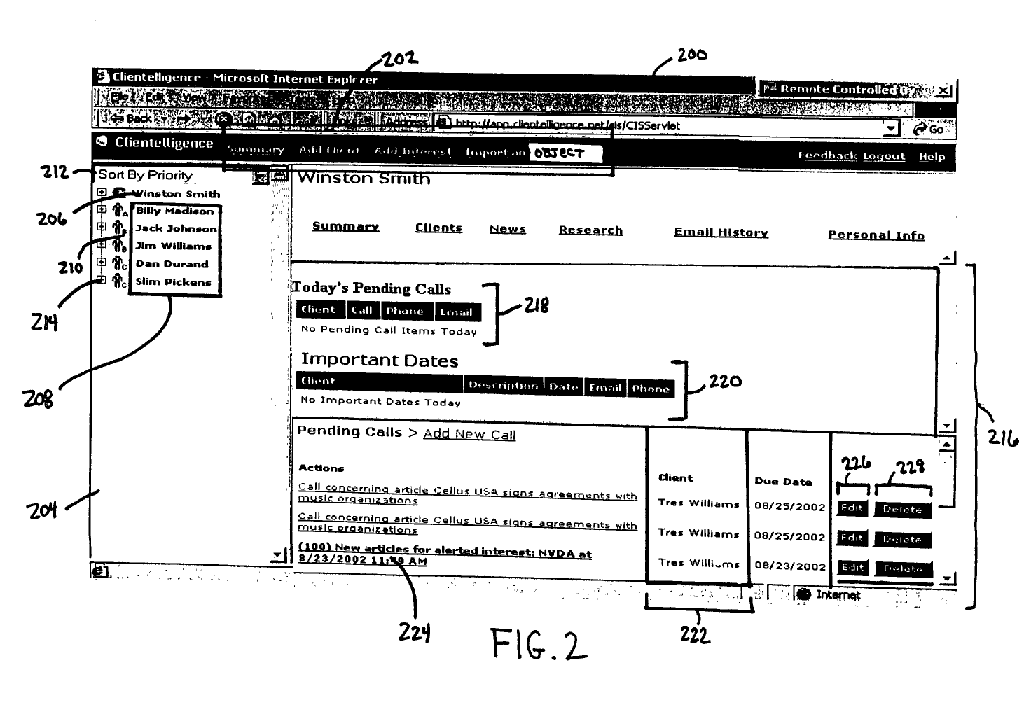

FIGS. 2-7 show illustrative screen shots that may be used to implement the systems and methods of the present invention. For example, the CRM application may be implemented in conjunction with a standard web browser application (e.g., Microsoft's Internet Explorer, Netscape Navigator, etc.) and accessed over the Internet. Alternatively, the CRM application may be implemented in conjunction with a commercially available software application interface and accessed over a public or private network, a proprietary software application interface and accessed over a private network, any other suitable platform, or a combination thereof. User input devices, such as a mouse, keyboard, or any other suitable user input device, may be used to interact with the application and may be included as part of user equipment 102 (e.g., personal computing device 101 of FIG. 1). Display devices such as a computer monitor, a handheld display, or any other suitable device, may be used to present information to the user.

To ensure the security and integrity of information used in connection with the present invention, a user may be required to log into the CRM application to access a particular user profile created by the user. Upon logging into the system, an illustrative main menu screen 200 may be displayed to the user as shown in FIG. 2. Main menu screen 200 may be provided by the CRM application and may include menu options 202, which may provide the user with an opportunity to perform various functions, such as add a client, add a user interest, or import an object. Menu options 202 may be available from any screen of the CRM application. For example, a user may access main menu screen 200 from any other screen in the CRM application by selecting the “Summary” option of menu options 202.

Client management frame 204 may be provided to present the names of the user and the user's clients. The user may be identified by selectable user text 206 and a client list 208, having each client listed in selectable client text, may appear below selectable user text 206. Each client may be assigned a priority 210 indicating the importance of the client to the user. Client list 208 may be sorted by name, priority 210, or by any other method by selecting the desired sort attribute from drop-down menu 212. A tree-structured menu having keyphrases related to client interests may be accessed for each client by selecting expand client option 214.

The CRM application may provide the user with an opportunity to review action items in action item frame 216 having today's pending calls list 218 and important dates list 220 where selectable items may be listed and selected by the user for action. For example, the user may have previously scheduled a call with a client, and a selectable call item may now appear in today's pending calls list 218. The user may select the call item to place a call to a client. The user may also have associated an important date with a client (e.g., a birthday, and anniversary, etc.) that is stored in the client's profile. Selectable date items may appear in important dates list 220 on the day they occur and the user may select a date item to take action (e.g., call the client and wish him a “Happy Birthday”).

Action items and alerts may also be displayed in alert frame 216. Alert frame 216 may include selectable objects 224, which may be objects recently retrieved from a search using keyphrases related to client interests previously set for alert and other related information. A user may have previously indicated that an alert be set for specific user-associated information (e.g., user keyphrases, etc.) or client-associated information (e.g., keyphrases related to client interests, client holdings, scheduled phone calls, etc.). Objects received that relate to user-associated or client-associated information that is set for alert may appear as selectable objects in alert frame 222. Selectable objects 224 may be edited by selecting a corresponding edit option 226 or deleted by selecting a corresponding delete option 228. Users may configure the CRM application to send reminders and alerts for items that appear in action item frame 216. reminders and alerts may be sent to the user or to clients via e-mail, telephone, wireless pager, or by any other suitable method.

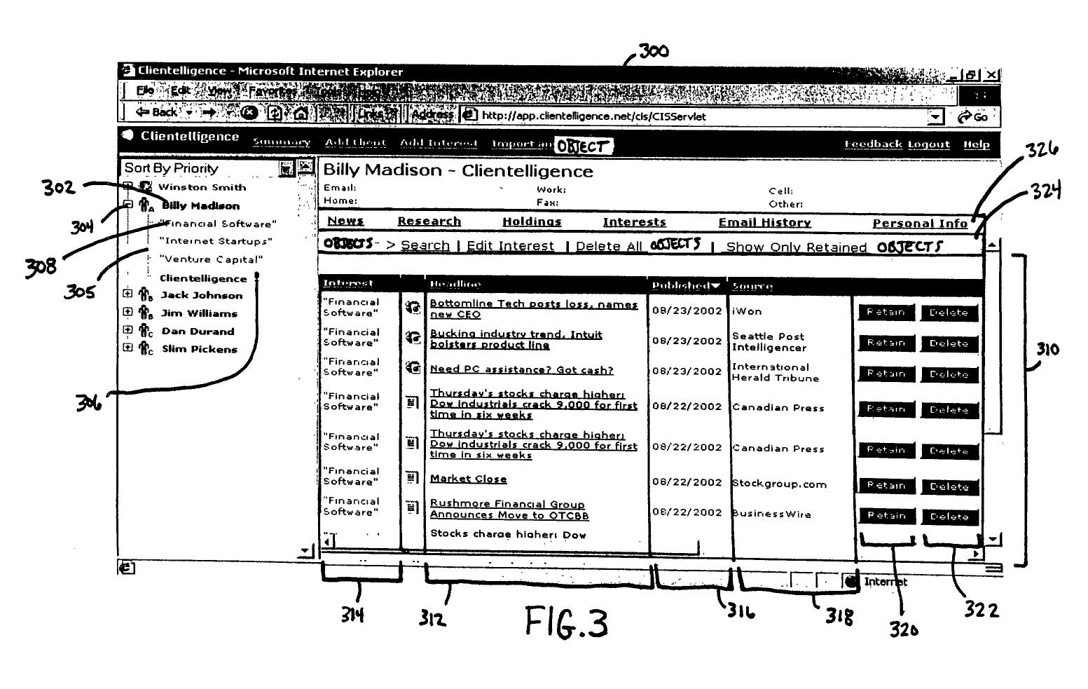

Client menu screen 300 of FIG. 3 may be presented to a user for managing information related to a particular client. A user may access client menu screen 300 by selecting selectable client text 302 that identifies a particular client. Expand client option 304 may be selected for client 302 to present a client keyphrase list 305 to the user. The CRM application may provide functions that allow the user to define client keyphrases, and the CRM application may provide the user with an opportunity to set an alert for any particular interest. Alert indicator 306 may appear in client keyphrase list 304 for keyphrases set for alert. By previously associating an alert with a keyphrase related to a client interest, the user may be automatically alerted of new information received related to a particular client interest. Alerts may be sent to a user or client via e-mail, telephone, wireless pager, or any other suitable method. A client-associated keyphrase 308 may be selected to initiate a search. Results of the search may appear in object frame 310.

Object frame 310 may include a list of objects 312 retrieved from a client keyphrase search. Objects may be stored in an application database (e.g., application database 106 of FIG. 1), cached in the memory of a device included in user equipment 102, or otherwise stored using any suitable method. The list of objects may include information related to the interest searched 314, the date the object was published 316, and the source of the object 318. A user may also be presented with the option to retain an object or delete an object from the list. By selecting retain option 320, the corresponding object may be stored in the application database and have a data attribute indicating that the object is retained. By selecting delete option 322, a user may remove the corresponding object from application database 106.

Object menu list 324 may provide the user with various selectable features and functions. For example, a user may initiate a search or refresh a prior search, edit an interest selected by the user, delete all objects related to a particular interest that have been stored in the application database, or view only those objects for which retain option 320 has previously been selected. Searches for objects may be scheduled by the user to occur at a particular time, occur continuously at a time interval determined by the user, or by any other method. The list of selectable objects may be dynamically updated each time the CRM application automatically initiates a search.

Client menu screen 300 may also include data silo menu 326. Data silos refer to groupings of information based on, for example, the type, source, or use of the information. Data silo menu 326 may be presented in each screen provided by the CRM application for each client selected, and may include selectable options directed to “News”, “Research”, “Holdings”, “Interests”, “E-mail History”, or “Personal Info” associated with a given client, or any other suitable groupings of information. Data silos such as “Product Information” (not shown) may also be provided. By selecting a client and data silo, information associated with that data silo and client may retrieved from the application database or an external information source and presented to the user. For example, a user may view a client's “Holdings” or “Interests” by selecting the client and the appropriate option from data silo menu 326.

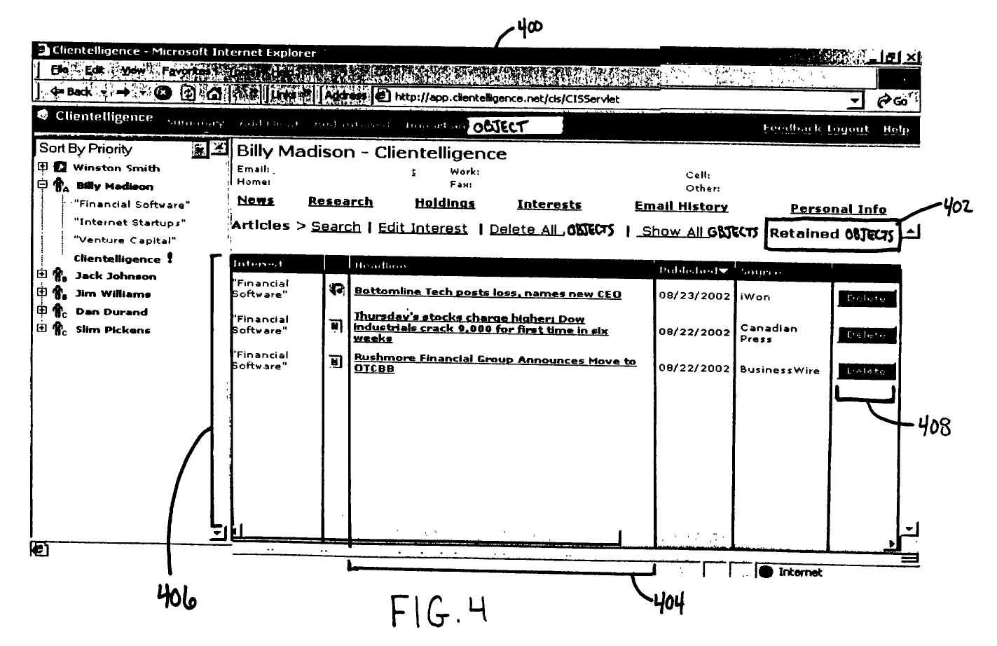

As previously discussed, the CRM application may provide the user with an opportunity to retain objects by storing selected objects with an associated retained object data attribute in application database 106 of FIG. 1. An illustrative retained objects menu screen 400 that may be displayed to a user is shown in FIG. 4. Retained objects menu screen 400 may be presented when a user decides to retain specific objects presented in object frame 310 (FIG. 3) by selecting retain option 320. By selecting “Retained Objects” option 402, only objects previously retained 404 may appear in retained object frame 406. Retained objects may be deleted and removed from the application database by selecting the corresponding delete option 408.

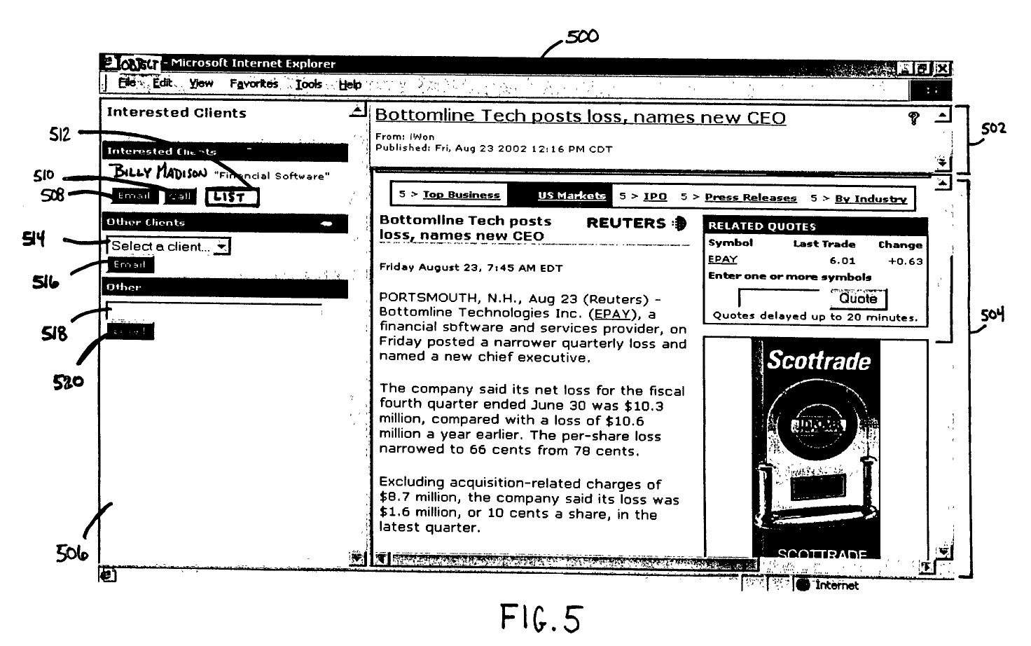

When an object is selected from object list frame 310 (FIG. 3), retained object frame 406 (FIG. 4), or any other frame having selectable objects, object communication menu screen 500 of FIG. 5 may be presented. A selected object's headline may be presented in headline frame 502, while the body of the object may be presented in object frame 504. Object frame 504 may support text and multimedia objects that are embedded in the frame. For example stored and real-time audio/visual multimedia objects may be presented to a user within object frame 504.

Object action frame 506 may be provided for a user to take action on a selected object. For example, a user may send the object to the selected client via e-mail by selecting e-mail option 508. A user may call the client directly from the object by selecting call option 510. A user may also chose to act on this item at a later time by selecting list option 512. From object action frame 506, a user may send the selected object to parties other than the selected client by using drop-down menu 514 to chose the desired client and selecting e-mail option 516. The user may also enter an e-mail address in text box 518 and e-mail the selected object to the entered address by selecting e-mail option 520.

By selecting call option 510 from object action frame 506, the CRM application may provide the user with an opportunity to place a telephone call to the client directly from object communication menu screen 500. The telephone call may be placed using a telephone application implemented on user equipment 102 (FIG. 1) in conjunction with the CRM application. Available methods and systems used to place a telephone call using a telephone application have been discussed in detail in connection with telephone application 111 of FIG. 1.

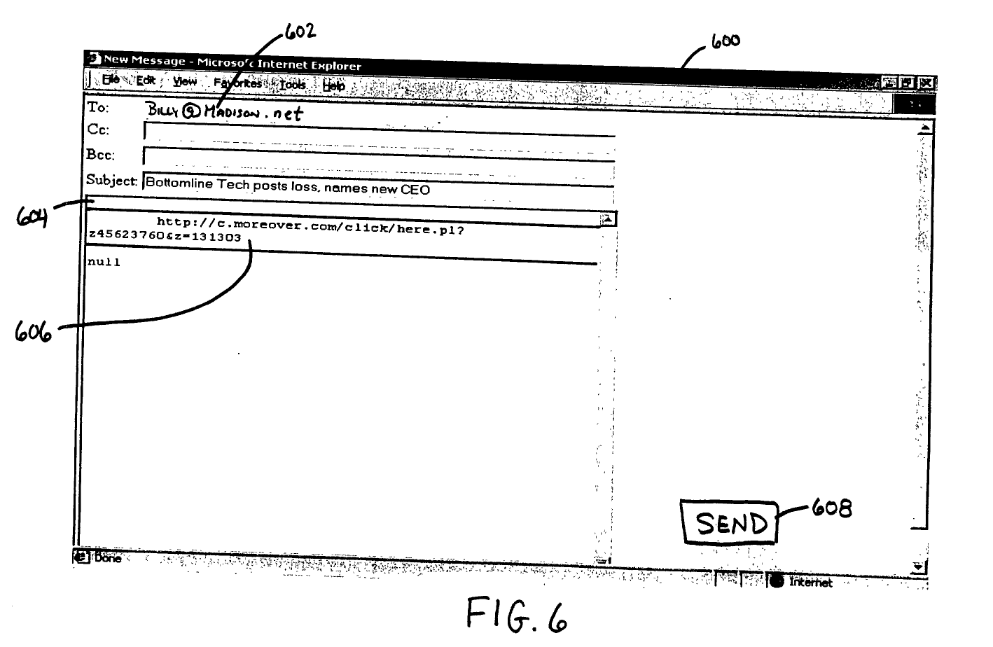

By selecting e-mail options 508, 516, or 520 from object action frame 506, a screen such as e-mail menu screen 600 of FIG. 6 may be provided for allowing a user to e-mail the selected object to the selected client. The client's e-mail address 602 may be automatically generated from the selected client's profile stored in the application database. The user may decide to include additional recipients to this e-mail by manually entering e-mail addresses in the “cc” and “bcc” entry fields. The user may also enter a subject or title to the e-mail in a title entry field. Text box 604 may be provided to allow the user to enter a message to the client receiving the e-mailed object. The object 606 may be attached to the e-mail, embedded in the e-mail, or accessible via a hyperlink included in the e-mail, and upon receiving the e-mail and object 606, the client may access the e-mailed object. The CRM application may send the email in response to the user selecting send option 608.

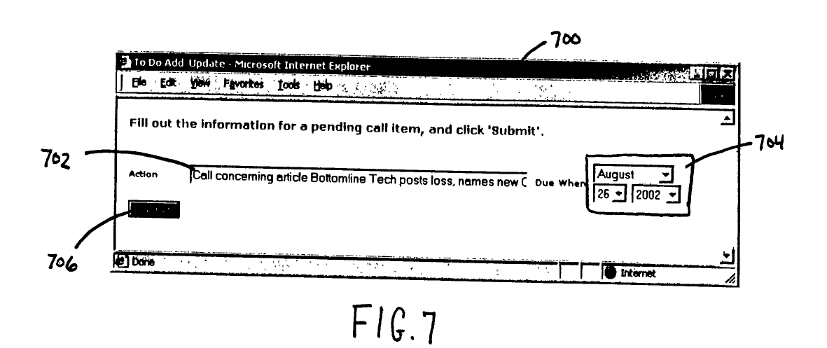

Referring back to FIG. 5, by selecting list option 512 from object action frame 506, action item menu screen 700 of FIG. 7 may be provided for allowing a user to add an object to an action item list, such as pending calls list 218, important dates list 220, or alert frame 222 (FIG. 2). The CRM application may provide the user with an opportunity to name the action to be added in action name entry text box 702. A default action name may be provided, which the user may overwrite to more particularly define the action item. The CRM application may also provide the user with an opportunity to select an action date for the selected object using drop-down menus 704. The user may then save the information provided to the application database by selecting submit option 706. Upon receiving indication from the user to save the information entered in action item menu screen 700, the CRM application may save the information to the application database and create an entry on an action item list.

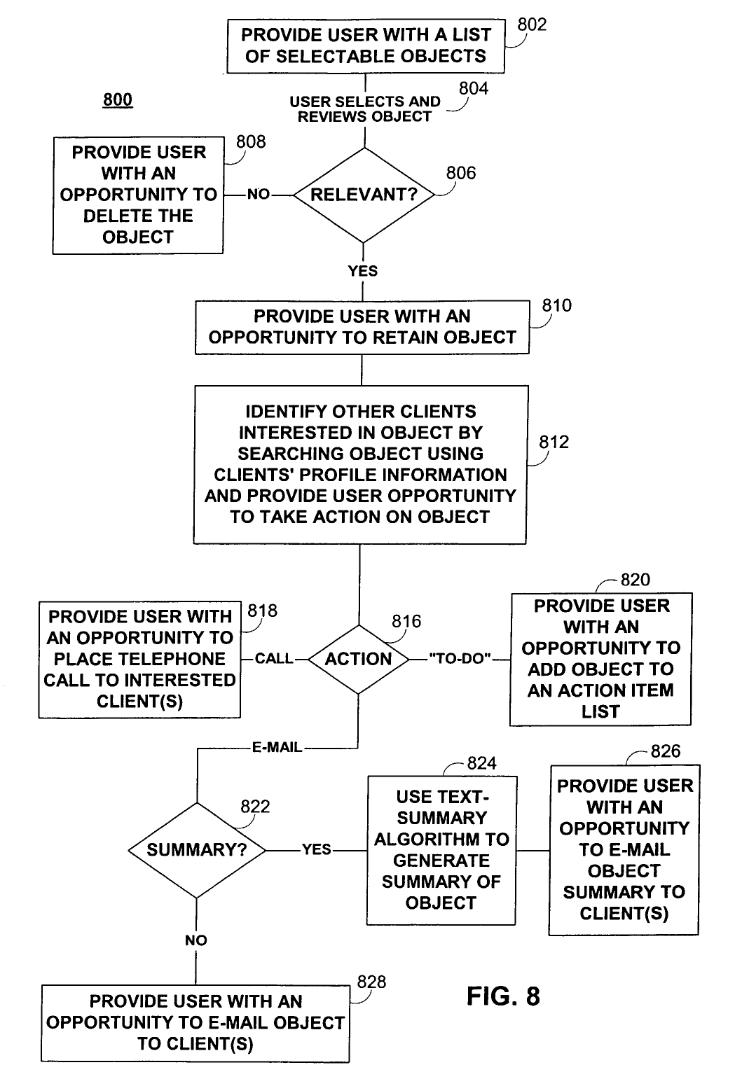

A flow chart 800 of illustrative steps that may be involved in managing and taking action on objects retrieved from a search is shown in FIG. 8. At step 802, a list of selectable objects retrieved from a search performed by CRM application 104 (FIG. 1) in conjunction with search agent 108 is presented to a user. Objects may be sorted according to their relevancy to the search or by any other suitable method. An object's relevancy to the search may be determined, for example, by calculating the number of instances the search parameter (e.g. the user-associated information or client-associated information searched) occurs in the object, or by any other suitable method. The user may select an object for review 804 and further determine the relevancy of the selected object at decision point 806. If the object is not relevant, the CRM application may provide the user with an opportunity to delete the selected object at step 808. If the object is relevant, the CRM application may provide the user with an opportunity to retain the object in a database such as application database 106 (FIG. 1) at step 810. At step 812, other clients interested in the selected object may be identified by the CRM application by searching the selected object using client-associated information from client profiles (e.g., keyphrases related to client interests, client holdings, etc.). At step 812, the CRM application may also provide the user with an opportunity to take action on the selected object.

The CRM application may provide the user with an opportunity to determine the appropriate action to take for the selected object at decision point 816. For example, the user may communicate the object to the client using a communication application or device. The CRM application may provide the user with an opportunity to place a telephone call to a selected client or clients using the telephone application and telephonic communication techniques previous discussed in connection with telephone application 111 of FIG. 1. The CRM application may also provide the user with an opportunity to add the selected object to an action item list at step 820 or to e-mail the object to the client(s).

In some cases, it may be desirable for a user to send a client a brief executive summary of an object, for example if the object would take a client too much time to read in its entirety. In such cases, the CRM application may provide the user with an opportunity to decide whether to send the client the entire object, a summary of the object, or both. A summary of a text-based object, such as a news article, may be generated using a text summary algorithm.

Text summary algorithms are widely available that are able to generate a summary of a text-based electronic document (e.g., a text file or a web page). Text summary algorithms may use artificial intelligence methods and techniques to reduce the text of a document or object into a short executive summary having only the most crucial information conveyed in a particular document or object. Simple text summary algorithms may provide a summary including only the first sentence of each paragraph of a document. More sophisticated text summary algorithms may, for example, generate a text summary by calculating the probability that each sentence belongs to the summary. A summary is then prepared based on the probabilities derived.

It will be understood that methods for generating a text summary using a text summary algorithm other that those described herein may also be used, and that the present invention may be used in conjunction with any available text summary algorithm. For example, commercial algorithms provided by companies such as AltaVista® or Convera™ may be used in conjunction with the application in order to achieve object summary capability. Text summary algorithms may be implemented by a processor or other hardware available as part of user equipment 102 and built into the CRM application or implemented with the CRM application as a separate software module.

If the user decides to e-mail the selected client or clients a summary of the article, a text summary algorithm may be applied to the selected text-based object to generate a summary of the object at step 824. At step 826, the summarized object may be e-mailed to the selected client or clients. At step 828, if the object is not to be summarized, the entire object may be e-mailed to the selected client or clients. The CRM application may also provide the user with an opportunity to e-mail the summarized object and the entire object to the client (not shown).

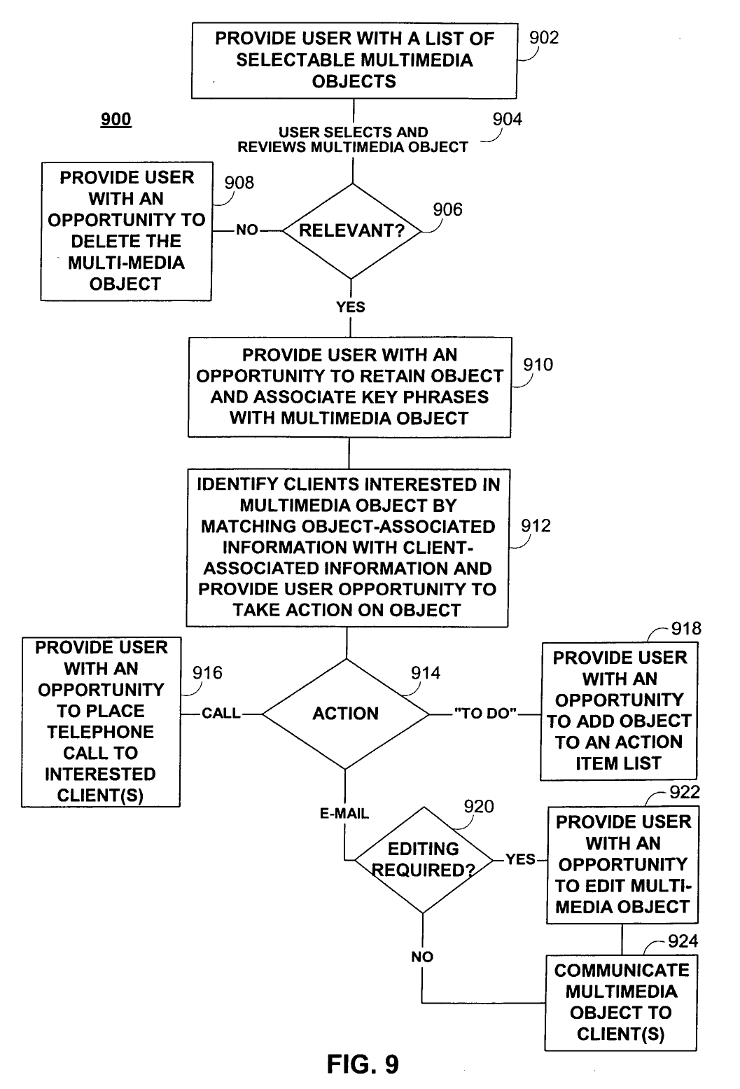

A flow chart 900 of illustrative steps that may be involved in managing and communicating to clients multimedia objects retrieved from a search is shown in FIG. 9. Multimedia objects may include more than one media format, for example, real-time streaming audio and video files, downloadable audio and video files, or information in any other suitable multimedia format. At step 902, a list of selectable multimedia objects retrieved from a search performed by CRM application 104 (FIG. 1) in conjunction with search agent 108 is presented to a user. Multimedia objects may be sorted according to their relevancy to the search or by any other suitable method. The user may select a multimedia object for review 904 and further determine the relevancy of the selected multimedia object at decision point 906. If the multimedia object is not relevant, the CRM application may provide the user with an opportunity to delete the selected multimedia object at step 908. If the object is relevant, the CRM application may provide the user with an opportunity to retain the multimedia object at step 910 and associate the multimedia object with keyphrases that describe the selected multimedia object (e.g., associating metadata with the selected multimedia object). The multimedia object and associated keyphrases may then be stored in the application database (e.g., application database 106 of FIG. 1).

At step 912, other clients interested in the selected multimedia object may be identified by the CRM application by matching the multimedia object's associated keyphrase metadata with client-associated information from client profiles (e.g., keyphrases related to client interests, client holdings, etc.). The CRM application may provide the user with an opportunity to take action on the selected multimedia object at step 912.

The CRM application may provide the user with an opportunity to determine the appropriate action to take for the selected object at step 914. The CRM application may provide the user with an opportunity to place a call to a selected client or clients using the telephone application and telephonic communication techniques previous discussed in connection with FIGS. 1 and 5 at step 916. The CRM application may also provide the user with an opportunity to add the selected multimedia object and associated client(s) to an action item list at step 918 or e-mail the object to the client(s).

Multimedia objects, for example real-time streaming broadcasts, stored audio and video files, and the like, may convey a variety of information to a user. Also, various portions of a multimedia object may relate to various subject matter, and a particular client may only be interested in a specific portion of the multimedia object. Therefore, after identifying additional clients interested in the multimedia object at step 912, the CRM application may provide the user with an opportunity to decide if the multimedia object should be edited at decision point 920. If editing is required, the CRM application may provide the user with an opportunity to edit the multimedia object using a media editing software (e.g., Sonic Founry®, Adobe® Premier®, etc.) or any other suitable device or application at step 922. The media editing software may be built into the CRM application or may be added onto the CRM application as a separate software module.

The CRM application may provide the user with an opportunity to communicate to the client via e-mail the finalized multimedia object at step 924. The CRM application may provide the user with an opportunity to send separate and variously edited clips of the selected multimedia object to different clients at step 924. If no editing is required, the user may send the entire multimedia object to the selected client or clients at step 924.

The CRM application also allows a user to enter information associated with a client's holdings. By including this information, the CRM application may provide the user with an opportunity to search for objects related to a client's holdings such as news articles, SEC Filings, research reports, or information related to newly available products having attributes similar to a client's existing holdings, or any other available information related to a client's holdings. Providing information about a client's holdings also allows the user to perform various portfolio management functions of a user's holdings (e.g., determine a product's performance over time, perform accounting functions, trade products, etc.).

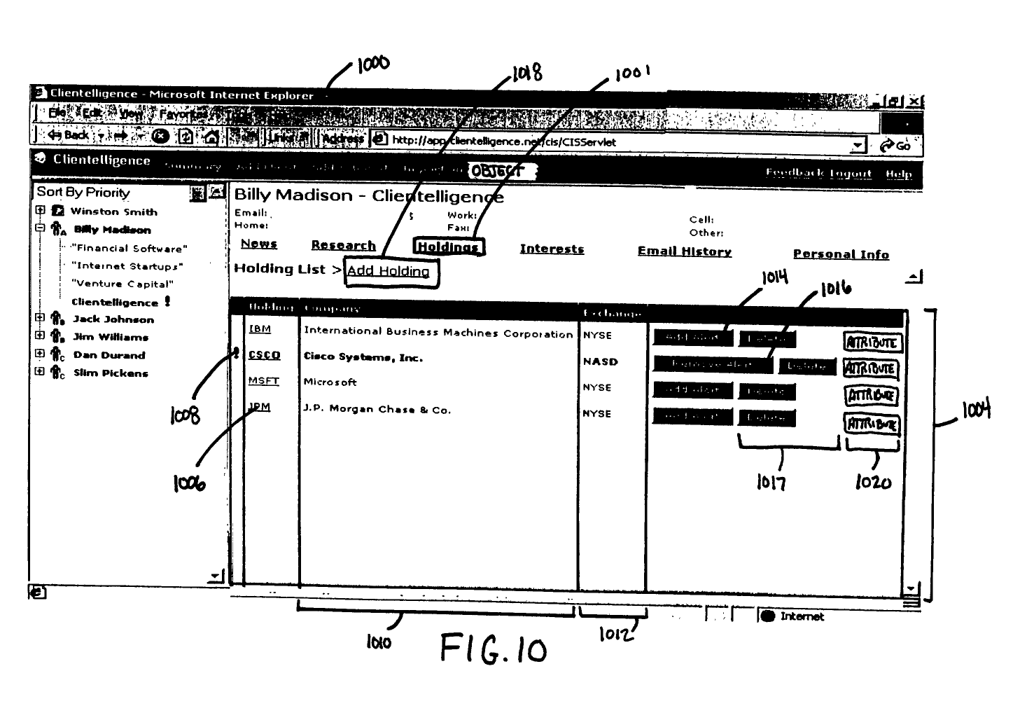

An illustrative client holdings menu screen 1000 that may be displayed for the user is shown in FIG. 10. Client holdings menu screen 1000 may be accessed from any other screen in the CRM application upon the user selecting holdings option 1001. Client holdings menu screen 1000 may include client holdings frame 1004 having a list of client holdings. Holdings frame 1004 may include selectable holdings text 1006, alert indicator 1008, company name 1010, exchange information 1012 and any other available information (e.g., volume and value of holding, etc.). The CRM application may also provide the user with an opportunity to select an alert option 1014 to add an alert for a particular holding, remove alert option 1016 to remove an alert from a particular holding, or a corresponding delete holding option 1017 to delete a particular holding. The CRM application may further provide the user with an opportunity to enter attributes of a client's holding by selecting attribute option 1020. Client holding attributes may also be provided to the CRM application by an external information source (e.g., external information source 116 and 120 of FIG. 1). Selectable holding text 1006 may also be selected by a user to provide more information related to a particular client holding (e.g., investment performance information, trading options, etc.) or to search for objects related to the selected holding.

Various other portfolio management tools and features may be incorporated as part of client holdings menu screen 1000 or as part of additional menu screens provided upon a user's selection of selectable holding text 1006. For example, the CRM application may include portfolio management tools that enable a user to electronically buy and sell products (e.g., stocks, bonds, etc.) online on behalf of a client, analyze a client's product portfolio (e.g., compute a return on investment), or perform any other suitable portfolio performance technique. The CRM application may provide the user with an opportunity to add additional client holdings and return to holding entry menu screen 1000 by selecting “Add Holding” option 1018.

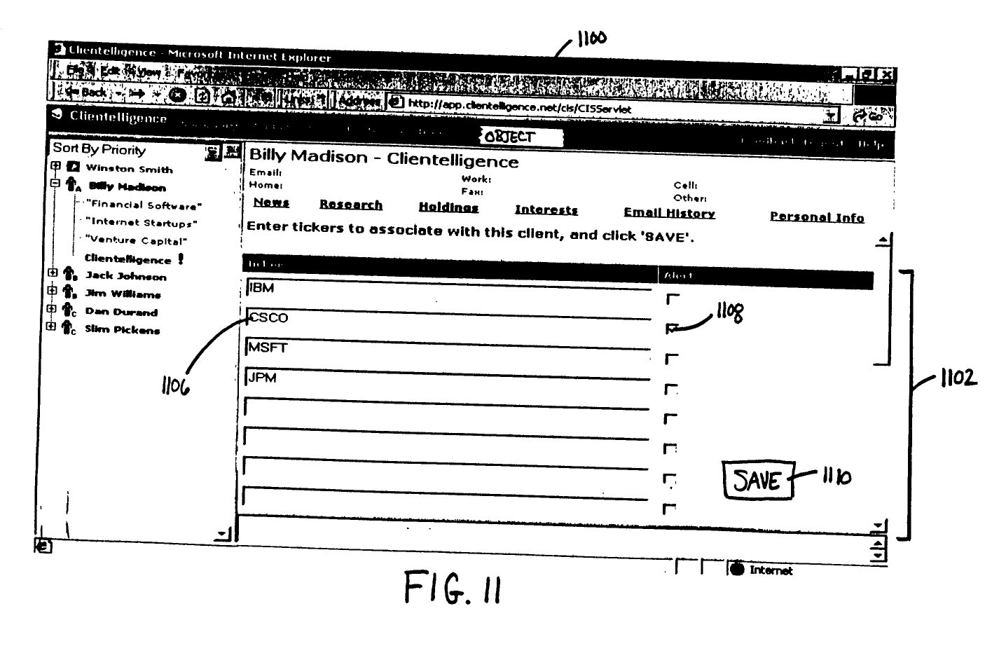

An illustrative holdings entry menu screen 1100 that may be displayed to the user in response to the user selecting “Add Holding” option 1018 (FIG. 10) is shown in FIG. 11. Holdings entry frame 1102 may be provided to allow the user to enter client holdings information. The CRM application may provide the user with an opportunity to enter ticker symbols or other holding-associated information that corresponds to a client's holdings in holding entry field 1106. The CRM application may also provide the user with an opportunity to select that an alert be associated with a particular holding by checking holding alert field 1108. By associating an alert with a client holding, the user may be automatically alerted of new information received related to a particular client holding (e.g., a research report, conference call, an SEC filing, etc.). Alerts may also be set to automatically alert a user or client of any newly received client holding-associated information via e-mail, telephone, wireless pager, or any other suitable method. The CRM application may provide the user with an opportunity to select “Save” option 1110 to store client holdings information in the application database. Attributes associated with a client's holdings (e.g., the name of a company or fund, industry, type of security or fund, etc.) describe and characterize the client's holding and may be received from an information source or entered by the user and stored in an application database (e.g., application database 106 of FIG. 1).

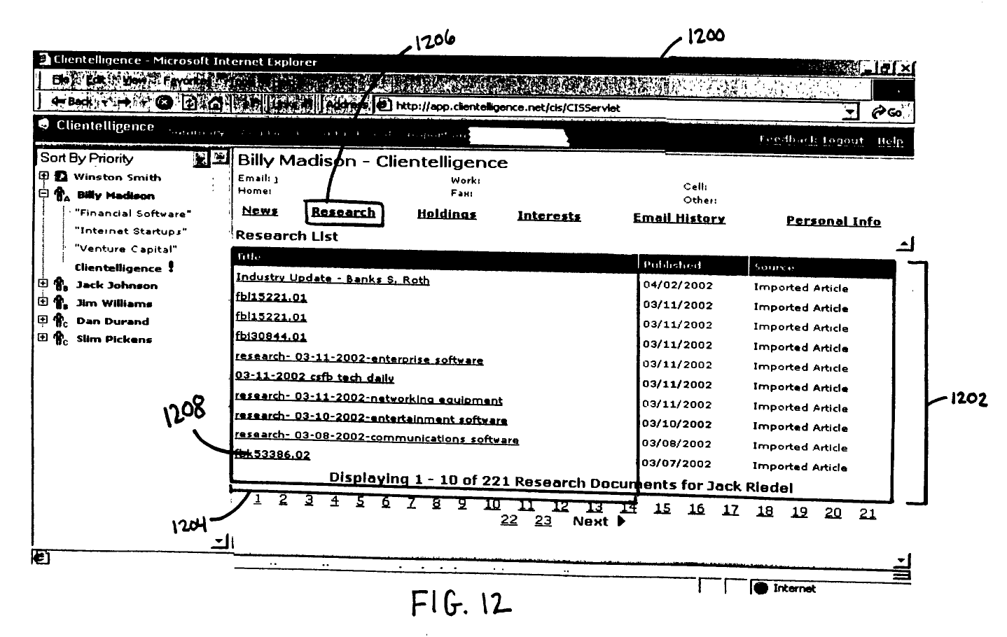

The CRM application may provide the user with an opportunity to search for research objects using information associated with the client's holdings (e.g., ticker symbol, company name, etc.). FIG. 12 shows research menu screen 1200 which may include research frame 1202 having research objects retrieved from a search in research object list 1204. The CRM application may search external information sources to retrieve research objects related to a selected client's holdings. The search for information related to client holdings may be initiated from any other screen provided by the CRM application in response to the user selecting “Research” option 1206. Research object list 1204 may include selectable research text that a user may select to access a particular research object. Research object list 1204 may also include information related to the publishing source, date of publication, or any other suitable information.

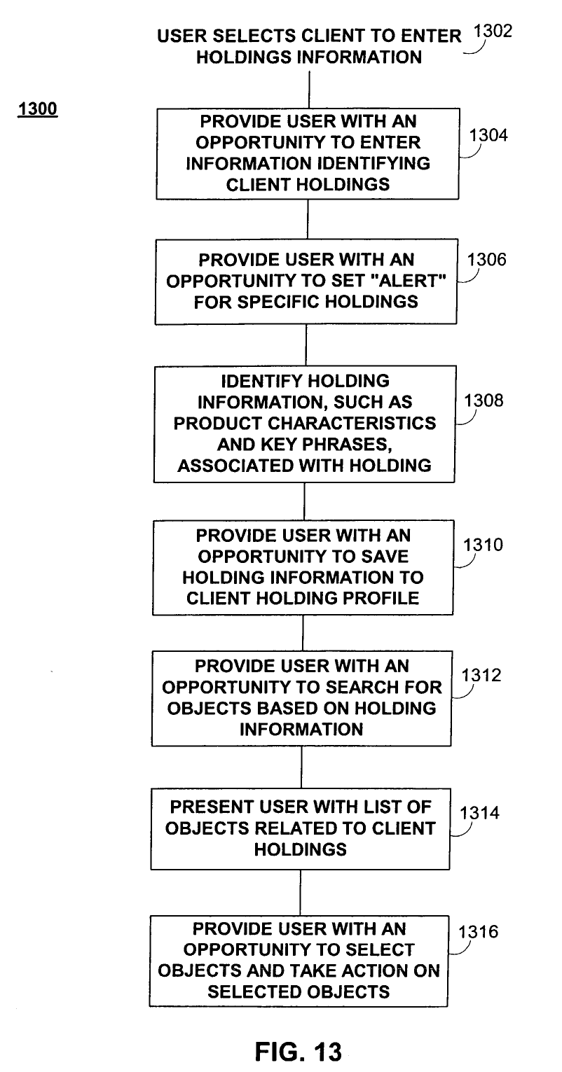

A flow chart 1300 of illustrative steps that may be involved in entering client holdings information and searching for objects using information associated with client holdings is shown in FIG. 13. The user may initially select a client for entering holdings information 1302. The CRM application may provide the user with an opportunity to enter information identifying the selected client's holdings at step 1304. At step 1306, the CRM application may provide the user with an opportunity to set an alert for specific client holdings. At step 1308, the CRM application may provide the user with an opportunity to identify information associated with entered client holdings, such as product attributes, keyphrases, or any other suitable information related to a specific client holding. Alternatively, this information may be provided by an information source and stored as part of a client's profile in the application database. Once client holding information has been entered by a user, the user may be provided with an opportunity to save the entered client holding information to the client's holdings profile, stored in the application database, at step 1310.

At step 1312, a user may be provided with an opportunity to search for objects related to a client's holdings. Holdings related objects provided by information sources may be searched using holding-associated keyphrases, for example a product name or symbol identifying a holding (e.g., a company's ticker symbol or company name). Objects retrieved from the search may be presented to the user as a list of client holding-related objects at step 1314. The objects retrieved may be presented to the user according to their relevancy to the search parameters, by the date the object was published, or by any other suitable method. A user may be provided an opportunity to select objects and take action on selected objects at step 1316 in a manner as described in connection with FIGS. 8 and 9.

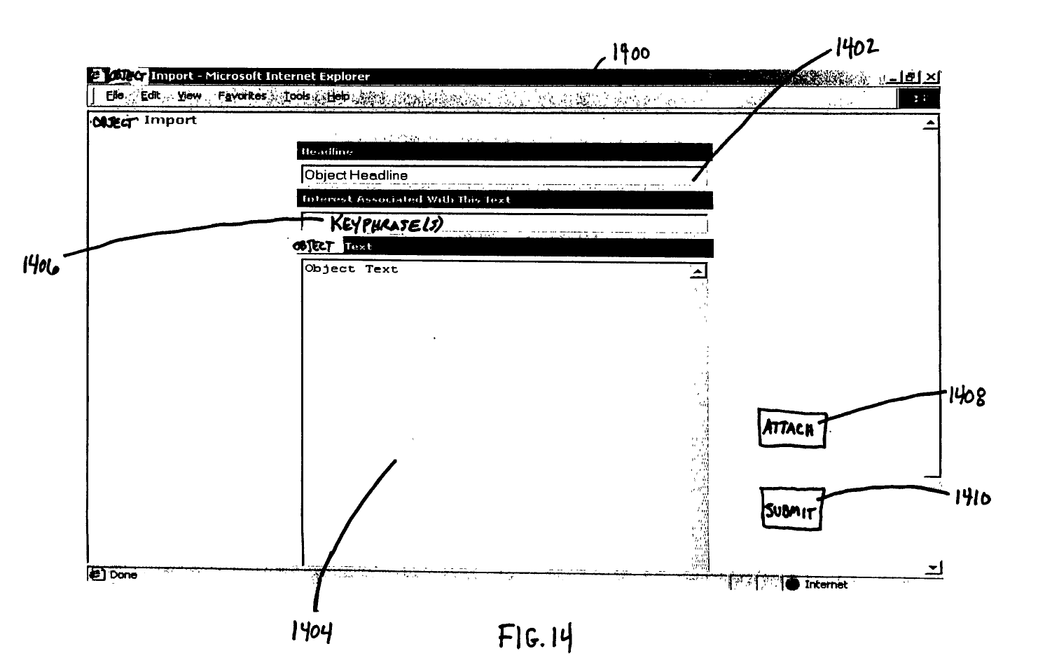

In some cases, a user may find an object from an outside information source (e.g., an information source not associated with or coupled to the CRM application) that is relevant to a client, and the user may desire to import that object to the CRM application. Users may import objects such as text and files using object import menu screen 1400 of FIG. 14. The CRM application may provide the user with an opportunity to provide information related to an imported object's headline in headline entry field 1402. If the object is text based, the CRM application may provide the user with an opportunity to paste the text object into object entry field 1404 and to provide keyphrases to identify the object in object keyphrase field 1406. If the object is a file (e.g., a portable document format file, image file, audio/video file, etc.), the CRM application may provide the user with an opportunity to attach the file by selecting attach option 1408. The CRM application may provide the user with an opportunity to store the object to an application database (e.g., application database 106 of FIG. 1) by selecting submit option 1410.

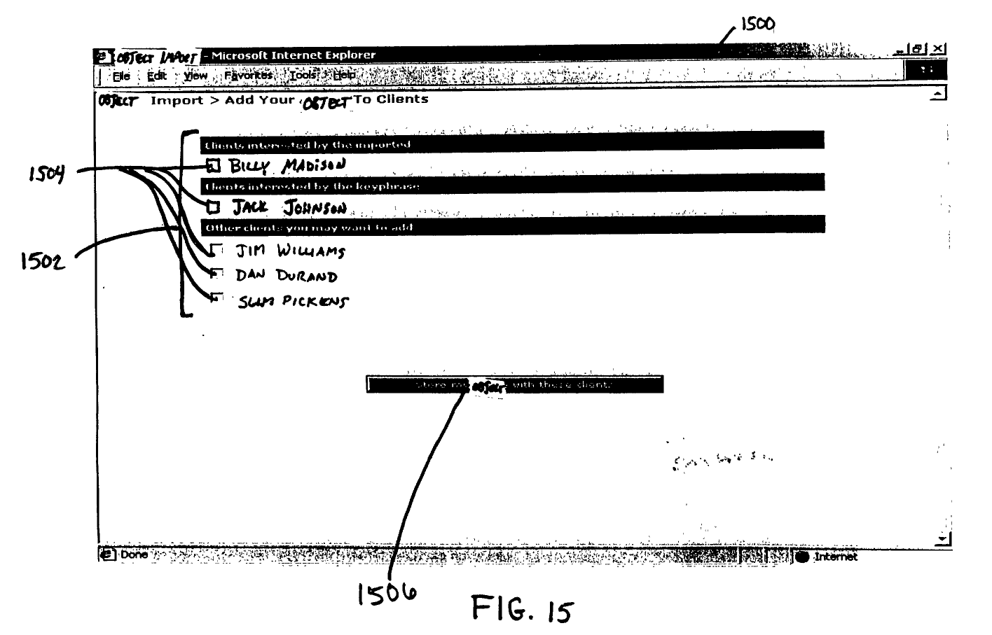

Once the object and related information has been stored in the application database upon the user's selection of submit option 1410, imported object relation menu screen 1500 of FIG. 15 may be provided to associate the imported object with clients. The CRM application may identify clients as having interest in the imported object by matching client-associated information from client profiles with information provided by the user and associated with the imported object. Clients may be identified as having interest in an imported object, for example, by searching the text entered in object entry field 1404 (FIG. 14) or object keyphrase entry field 1406 using client-associated information (e.g., keyphrases related to client interests, client holdings, etc.), or by using client-associated information to search the text of an imported file. The CRM application may provide interested client list 1502 to a user, having a list of clients that may be interested in the imported object (e.g., clients with client-associated information matching the object text or associated keyphrases). The CRM application may provide the user with an opportunity to select specific clients (e.g., by selecting a corresponding select field 1504) and store the imported object in the application database as being associated with the selected client(s) by selecting store option 1506.

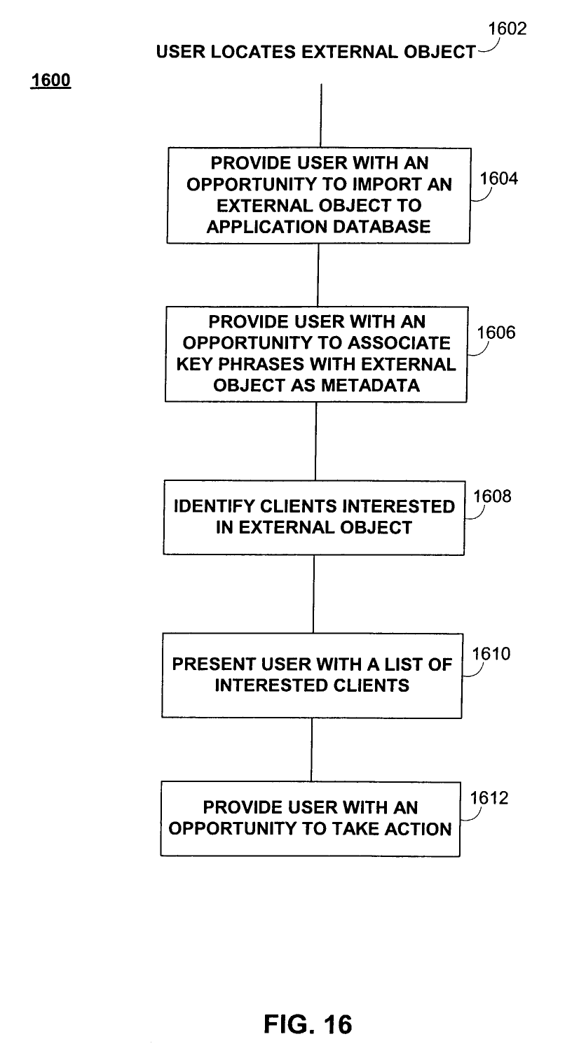

A flow chart 1600 of illustrative steps that may be involved in importing an object to an application database is shown in FIG. 16. A user may locate an external object to import at step 1602. At step 1604, the CRM application may provide the user with an opportunity to import the external object to the application database. At step 1606, the CRM application may provide the user with an opportunity to associate keyphrases with the external object. The keyphrases may be associated with the object and stored as metadata in the application database. Clients that may be interested in the external object may then be identified at step 1608 using, for example, client-associated information to search the object or by matching client-associated information with the object-associated keyphrases identified by the user in step 1606. At step 1610, a list of clients interested in the imported object may be presented to the user, and the CRM application may provide the user with an opportunity to take action on the object at step 1612 in a manner as described in connection with FIGS. 8 and 9.

The present invention also provides enhanced CRM functionality by receiving information from a variety of information sources. For example, the CRM application may receive from product vendors information about products having identifiable product attributes. Product information and attributes may be provided to the CRM application by the user or by an information source. The CRM application may then associate to clients the product information received by matching client-associated information with product attributes.

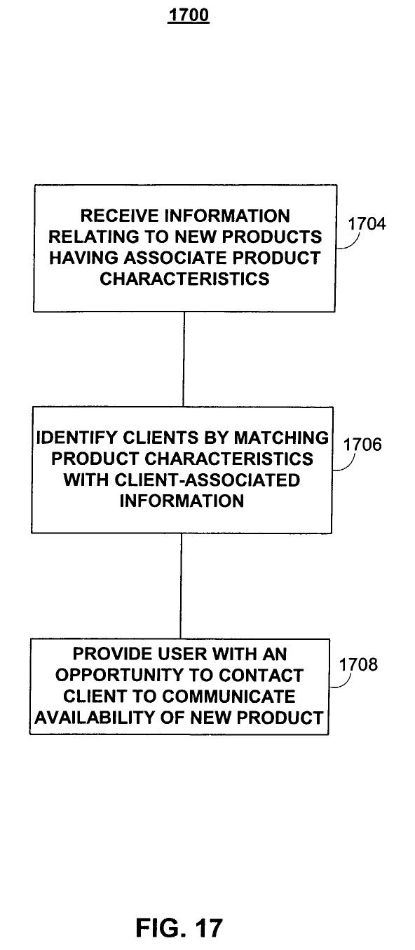

A flow chart 1700 of illustrative steps that may be involved in associating clients with products is shown in FIG. 17. Information related to products and product attributes may be received from an information source or provided by the user at step 1704. Product-associated information may be attributes related to the product. At step 1706, the CRM application identifies clients interested in the products by using a search agent or other device to match client-associated information (e.g., keyphrases related to client interests, client holding attributes, etc.) with product-associated information. At step 1708, a user may be provided with an opportunity to communicate to clients the availability of products via an e-mail application, a telephone application, any other suitable communication application, or a combination thereof.

For example, the user may receive information about a new municipal bond from an information source. The municipal bond may have attributes such as the interest rate of the bond, the location of the municipality of the bond, etc. These attributes may then be matched with client-associated information from client profiles (e.g., client holding attributes may be matched with product attributes). If client-associated information for a particular client matches product attributes, that clients may be more likely to purchase the product, and the user may have better success in offering the product to the particular client. The CRM application may use a search agent or any other suitable data processing method to match client-associated information with product attributes.

Other information that may be received by the CRM application may include television program information provided by a television information source. In addition to television video and audio signals, a television information source (e.g., a television distribution facility, a satellite, a cable headend, or any other suitable device or devices) may broadcast information related to the programs being broadcast. For example television program listings, closed captioned text in ASCII format, or any other suitable information may be provided by a television information source in addition to television programming. Television program listing are typically provided to television program guides to assist users in navigating television program options, while closed captioned text is traditionally used to present on-screen text for the hearing impaired.

Television program information may be provided to the CRM application by the television information source in the same signal(s) as the audio and video signal(s) or in a separate signal. The television program information may be decoded by the CRM application if needed. The television program information may be received and temporarily stored by the CRM application (e.g., stored in application database 106 of FIG. 1, cached in memory, etc.), and searched using user-associated information or client-associated information (e.g., keyphrases related to client interests, client holdings, etc.). Television programs that may be of interest to a user or client may thereby be identified by the CRM application.

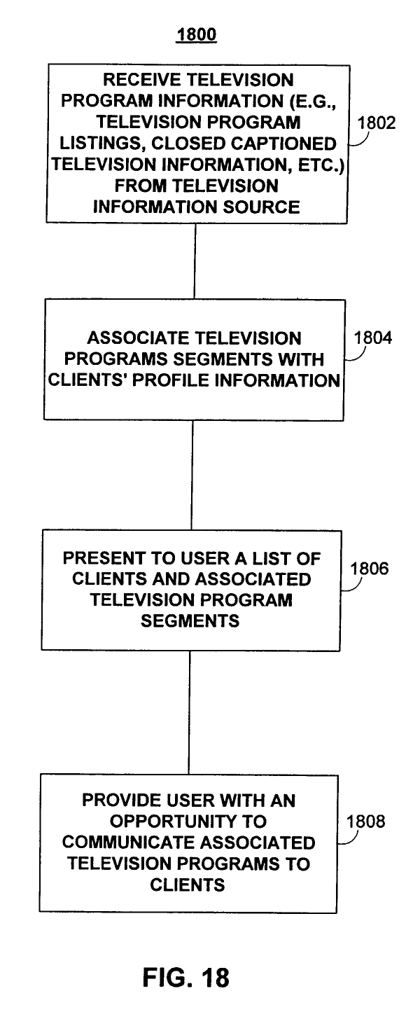

A flow chart 1800 of illustrative steps that may be involved in receiving television program information and matching television programs to clients is shown in FIG. 18. At step 1802, television program information from a television information source may be received at the CRM application. The television program information may be decoded and stored in the application database as it is received by the CRM application. The television program information may then be searched using client-associated information, and television programs may be associated with particular clients based on the client-associated information at step 1804. At step 1806, a list of clients and associated television programs may be presented to the user. The CRM application may then provide the user with an opportunity to communicate to clients (using any of the previously discussed communication techniques) that an associated television program has occurred, is occurring, or will occur in the future at step 1808. The user may also be provided with an opportunity to send identified programs to selected clients.

For example, a client may have previously indicated an interest in horse racing, and the user may have entered “horse racing” as a keyphrase related to the client's interests. The CRM application may receive television program listings or closed captioned television information from a television source broadcasting the Kentucky Derby. The television program information related to the Kentucky Derby broadcast may be received by the CRM application, decoded, stored in the application database, and searched using client-associated information (e.g., the “horse racing” keyphrase). The broadcast of the Kentucky Derby may include television program information having the term “horse racing” (e.g., as part of closed captioned text, an attribute of the Kentucky Derby television program listing, etc.) and the user may be alerted that a broadcast of the Kentucky Derby has occurred, is occurring, or is going to occur in the future (depending on when the user receives this information). The user may then contact the client to discuss the Kentucky Derby by telephone (e.g., using a telephone application), send the program listing or a link to the program via e-mail, or contact the client by any other suitable method.

The foregoing is merely illustrative of the principles of this invention and various modifications may be made by those skilled in the art without departing from the scope and spirit of the invention. Those skilled in the art will appreciate that the present invention may be practiced by other than the described embodiments, which are presented for purposes of illustration and not of limitation, and the present invention is limited only by the claims.

What is claimed is:

1. A method for allowing a user of a client relationship management application implemented on user equipment to communicate information to a client, the method comprising:
presenting to the user a user interface having a list of selectable objects retrieved from a search of at least one information source using client-associated information stored in an application database;
providing the user with an opportunity to select at least one object in the list of selectable objects; and
providing the user with an opportunity to communicate to the client information related to a selected object using a telephone application.

2. The method of claim 1 wherein the telephone application uses a private branch exchange to connect a telephone call to the client.

3. The method of claim 1 wherein the telephone application uses a public switched telephone network to connect a telephone call to the client.

4. The method of claim 1 wherein the telephone application uses a network supporting a voice-enabled Internet Protocol to connect a telephone call to the client.

5. The method of claim 1 wherein the client-associated information is a keyphrase related to the client's interest.

6. The method of claim 1 wherein the list of selectable objects retrieved from the search is sorted according to relevancy.

7. The method of claim 1 further comprising providing the user with alerts when objects are retrieved from the search.

8. The method of claim 1 further comprising providing the client with alerts when objects are retrieved from the search.

9. The method of claim 1 further comprising retrieving a client telephone number stored in the application database and dialing the client telephone number with the telephone application.

10. A client relationship management system for communicating information to at least one client, wherein the system includes user equipment configured to receive objects from at least one information source, the system comprising:
at least one application database for storing client-associated information;
a search agent for searching the at least one information source to identify objects related to the client-associated information;
a display device for presenting to the user a user interface having a list of identified objects;
a user input device for allowing the user to select at least one of the identified objects; and
a telephone application for allowing the user to communicate to the client information related to the identified object.

11. The system of claim 10 wherein the telephone application uses a private branch exchange to connect a telephone call to the client.

12. The system of claim 10 wherein the telephone application uses a public switched telephone network to connect a telephone call to the client.

13. The system of claim 10 wherein the telephone application uses a network supporting a voice-enabled Internet Protocol to connect a telephone call to the client.

14. The system of claim 10 wherein the client-associated information is a keyphrase related to the client's interest.

15. The system of claim 10 wherein the list of selectable objects retrieved from the search is sorted according to relevancy.

16. The system of claim 10 wherein the CRM application alerts the user when objects are retrieved from the search.

17. The system of claim 10 wherein the CRM application alerts the client when objects are retrieved from the search.

18. The system of claim 10 wherein the telephone application uses a client telephone number retrieved from the application database to place a telephone call to the client.

19. A machine-readable medium for use in allowing users to communicate information to clients, comprising machine program logic recorded thereon for:
presenting to the user a user interface having a list of selectable objects retrieved from a search of at least one information source using client-associated information stored in an application database;
providing the user with an opportunity to select at least one object in the list of selectable objects; and
providing the user with an opportunity to communicate to the client information related to a selected object using a telephone application.

20. The machine readable medium of claim 19 wherein the telephone application uses a private branch exchange to connect the telephone call.

21. The machine readable medium of claim 19 wherein the telephone application uses a public switched telephone network to connect a telephone call to the client.

22. The machine readable medium of claim 19 wherein the telephone application uses a network supporting a voice-enabled Internet Protocol to connect a telephone call to the client.

23. The machine readable medium of claim 19 wherein the client-associated information is a keyphrase based on the client's interest.

24. The machine readable medium of claim 19 further comprising machine program logic recorded thereon for sorting the list of selectable objects retrieved from the search according to relevancy.

25. The machine readable medium of claim 19 further comprising machine program logic recorded thereon for providing the user with alerts when objects are retrieved from the search.

26. The machine readable medium of claim 19 further comprising machine program logic recorded thereon for providing the client with alerts when objects are retrieved from the search.

27. The machine readable medium of claim 19 further comprising machine program logic recorded thereon for retrieving a client telephone number stored in the application database and dialing the client telephone number with the telephone application.

28. A method for communicating summarized information to a client, the method comprising:
presenting to a user a user interface having a list of selectable objects identified from a search of at least one information source using client-associated information stored in an application database;
providing the user with an opportunity to select an identified object and to generate a summary of the selected object; and
generating an object summary for the selected object using a text summary algorithm.

29. The method of claim 28 further comprising providing the user with an opportunity to communicate to the client the selected object, the selected object summary, or both using a communication application.

30. The method of claim 29 wherein the communication application is an e-mail application.

31. The method of claim 29 wherein the communication application is a telephone application.

32. The method of claim 28 wherein the client-associated information is a keyphrase related to the client's interests.

33. A client relationship management system for communicating summarized information to a client, wherein the system includes user equipment configured to receive objects from at least one information source, the system comprising:
at least one application database for storing client-associated information;
a search agent for searching the at least one information source to identify objects related to the client-associated information;
a display device for presenting to the user a user interface having a list of identified objects;
a user input device for allowing the user to select an identified object; and
a processor having a text summary algorithm for generating a summary of the selected object.

34. The system of claim 34 further comprising a communication application for allowing the user to communicate to the client the selected object, the selected object summary, or both.

35. The system of claim 34 wherein the communication application is an e-mail application.

36. The system of claim 34 wherein the communication application is telephone application.

37. The system of claim 33 wherein the client-associated information is a keyphrase related to the client's interests.

38. A machine-readable medium for use in communicating summarized information to a client, comprising machine program logic recorded thereon for:
presenting to a user a user interface having a list of selectable objects identified from a search of at least one information source using client-associated information stored in an application database;
providing the user with an opportunity to select an identified object and to generate a summary of the selected object; and
generating an object summary for the identified object using a text summary algorithm.

39. The machine-readable medium of claim 36 further comprising machine program logic recorded thereon for allowing the user to communicate to the client the object, the object summary, or both using a communication application.

40. The machine-readable medium of claim 37 wherein the communication application is an e-mail application.

41. The machine-readable medium of claim 37 wherein the communication application is a telephone application.

42. The machine-readable medium of claim 36 wherein the client-associated information is a keyphrase related to the client's interests.

43. A method for obtaining and displaying to a user information related to a client's holdings, the method comprising:
storing client holdings information in at least one application database;
receiving attributes associated with the client holdings information from at least one information source;
using the client holdings information and associated attributes to search information in at least one information source;
presenting to the user a list of selectable objects identified by the search;
providing the user with an opportunity to select an object from the list of identified objects; and
providing the user with an opportunity to communicate the selected object to the client.

44. The method of claim 43 further comprising allowing the user to communicate the object to the client via e-mail.

45. The method of claim 43 further comprising allowing the user to communicate the object to the client via telephone.

46. The method of claim 43 wherein the selected object is a news article, SEC Filing, research report, or related information.

47. The method of claim 43 wherein the selected object is product information for a product having attributes similar to the client's holdings.

48. The method of claim 43 wherein the list of selectable objects retrieved from the search is sorted according to the relevancy of the search.

49. The method of claim 43 further comprising providing the user with alerts when objects are retrieved from the search.

50. The method of claim 43 further comprising providing the client with alerts when objects are retrieved from the search.

51. A client relationship management system for communicating to a client objects related to the client's holdings, wherein the system includes user equipment for receiving objects from at least one information source, the system comprising:
at least one application database for storing client holdings information and associated attributes;
a search agent for searching the at least one information source to identify objects related to the client's holdings information and associated attributes;
a display device for presenting to the user a user interface having a list of identified objects;
a user input device for allowing the user to select at least one of the identified objects; and
a communication application for allowing the user to communicate the selected object to the client.

52. The system of claim 51 wherein the communication application is an e-mail application.

53. The system of claim 51 wherein the communication application is telephone application.

54. The system of claim 51 wherein the selected object is a news article, SEC Filing, research report, or related information.

55. The system of claim 51 wherein the selected object is product information for a product having attributes similar to the client's holdings.

56. The system of claim 51 wherein the list of selectable objects retrieved from the search is sorted according to the relevancy of the search.

57. The system of claim 51 further comprising providing the user with alerts when objects are retrieved from the search.

58. The system of claim 51 further comprising providing the client with alerts when objects are retrieved from the search.

59. A machine-readable medium for use in communicating to a client objects related to the client's holdings, comprising machine program logic recorded thereon for:
storing client holdings information and associated attributes in at least one application database;
using the client holdings information and associated attributes to search information in at least one information source;
presenting to the user a list of selectable objects identified by the search;
providing the user with an opportunity to select an object from the list of identified objects; and
providing the user with an opportunity to communicate the selected object to the client.

60. The machine-readable medium of claim 59 further comprising allowing the user to communicate the object summary to the client via e-mail.

61. The machine-readable medium of claim 59 further comprising machine program logic recorded thereon for allowing the user to communicate the object summary to the client via telephone.

62. The machine-readable medium of claim 59 wherein the selected object is a news article, SEC Filing, research report, or related information.

63. The machine-readable medium of claim 59 wherein the selected object is product information for a product having attributes similar to the client's holdings.

64. A method for searching television program information, comprising:
storing on at least one application database information associated with a client;
receiving from a television information source television program information;
storing on the at least one application database the television program information;
searching the television program information using the information associated with the client; and
presenting to a user a user interface having a list of television programs identified by the search.

65. The method of claim 64 further comprising providing the user with an opportunity to communicate to at least one client the identified television programs using a communication application.

66. The method of claim 64 wherein the communication application is an e-mail application.

67. The method of claim 64 wherein the communication application is a telephone application.

68. The method of claim 64 wherein the television information source is a broadcast television distribution facility.

69. The method of claim 64 wherein the television information source is a satellite television distribution facility.

70. The method of claim 64 wherein the television information source is a cable system headend.

71. The method of claim 64 wherein the television program information is television program listings information.

72. The method of claim 64 wherein the television program information is closed captioned text information.

73. A system for searching television program information received from a television information source, the system comprising:
user equipment for receiving the television program information;
at least one application database for storing client-associated information and the television program information;
a search agent for identifying television program information related to the client-associated information; and
a display screen for presenting to a user the television program information identified by the search agent.

74. The system of claim 73 further comprising a communication application for communicating to at least one client television programs identified by the search.

75. The system of claim 73 wherein the communication application is an e-mail application.

76. The system of claim 73 wherein the communication application is a telephone application.

77. The system of claim 73 wherein the television information source is a broadcast television distribution facility.

78. The system of claim 73 wherein the television information source is a satellite television distribution facility.

79. The system of claim 73 wherein the television information source is a cable system headend.

80. The system of claim 73 wherein the television program information is television program listings information.

81. The system of claim 73 wherein the television program information is closed captioned text information.

82. A machine-readable medium for use in searching television program information received from a television information source, comprising machine program logic recorded thereon for:
storing on at least one application database information associated with a client;
receiving from a television information source television program information;
storing on the at least one application database the television program information;
searching the television program information using the information associated with the client; and
presenting to a user a user interface having a list of television programs identified by the search.

83. The machine-readable medium of claim 82 further comprising machine program logic recorded thereon for providing the user with an opportunity to communicate to at least one client the identified television programs using a communication application.

84. The machine-readable medium of claim 82 wherein the communication application is an e-mail application.

85. The machine-readable medium of claim 82 wherein the communication application is a telephone application.

86. The machine-readable medium of claim 82 wherein the television information source is a broadcast television distribution facility.

87. The machine-readable medium of claim 82 wherein the television information source is a satellite television distribution facility.

88. The machine-readable medium of claim 82 wherein the television information source is a cable system headend.

89. The machine-readable medium of claim 82 wherein the television program information is television program listings information.

90. The machine-readable medium of claim 82 wherein the television program information is closed captioned text information.

91. A method for identifying products of interest to a client, the method comprising:
storing in at least one application database information associated with the client;
receiving from at least one information source product information having at least one product attribute for describing each available product; and
associating the client with at least one product by matching the at least one product attribute with the information associated with the client.

92. The method of claim 91 further comprising providing the user with an opportunity to communicate to at least one client the at least one product using a communication application.

93. The method of claim 91 wherein the information associated with the client is client holdings information.

94. The method of claim 91 wherein the information associated with the client is a keyphrase related to a client interest.

95. The method of claim 91 wherein the information associated with the client is personal information.

96. The method of claim 91 wherein the at least one information source is a product vendor.

97. A client relationship management system for identifying products of interest to a client, comprising:
at least one application database for storing information associated with the client;
at least one information source having product information including at least one product attribute for describing each available product; and
a search agent for associating the client with at least one product by matching the at least one product attribute with the information associated with the client.

98. The system of claim 97 further comprising a communication application for communicating to at least one client the at least one product.

99. The system of claim 97 wherein the information associated with the client is client holdings information.

100. The system of claim 97 wherein the information associated with the client is a keyphrase related to a client interest.

101. The system of claim 97 wherein the information associated with the client is personal information.

102. The system of claim 97 wherein the at least one information source is a product vendor.

103. A machine-readable medium for use in identifying products of interest to a client, comprising machine program logic recorded thereon for:
storing in at least one application database information associated with the client;
receiving from at least one information source product information having at least one product attribute for describing each product; and
associating the client with at least one product by matching the at least one product attribute with the information associated with the client.

104. The machine-readable medium of claim 103 further comprising machine program logic recorded thereon for providing the user with an opportunity to communicate to at least one client the at least one product using a communication application.

105. The machine-readable medium of claim 103 wherein the information associated with the client is client holdings information.

106. The machine-readable medium of claim 103 wherein the information associated with the client is a keyphrase related to a client interest.

107. The machine-readable medium of claim 103 wherein the information associated with the client is personal information.

108. The machine-readable medium of claim 103 wherein the at least one information source is a product vendor.
